(19) United States
(12) Patent Application Publication
(10) Pub. No.: US 2016/0364668 A1
(43) Pub. Date: Dec. 15, 2016

(54) SYSTEM AND METHOD FOR CREATION OF A PRIVATE BUSINESS WORKSPACE ON A SOCIAL NETWORK

(71) Applicant: Shocase, Inc., San Fransisco, CA (US)

(72) Inventors: Ronald P. Young, Mill Valley, CA (US); Peter Rugg, New York, NY (US)

(21) Appl. No.: 15/179,962

(22) Filed: Jun. 10, 2016

Related U.S. Application Data
(60) Provisional application No. 62/174,905, filed on Jun. 12, 2015.

(51) Int. Cl. G06Q 10/06; H04L 12/58; H04L 29/08; G06Q 50/00

(52) U.S. Cl. CPC G06Q 10/06313; G06Q 50/01; H04L 51/12; H04L 67/306

(57) ABSTRACT

One aspect includes a method for use in operating a social network. The method comprises the steps of: providing the social network comprising a public section and a private section; providing access to the public section to all users of the social network; and providing access to the private section only to one or more users associated with at least a specific project or entity.

### CROSS-REFERENCE TO RELATED APPLICATIONS

This application claims priority to U.S. Provisional Patent Application Ser. No. 62/174,905, filed Jun. 12, 2015, entitled “System and Method for Creation of a Private Business Workspace on a Social Network,” which is hereby incorporated by reference herein in its entirety.

This application is also related to U.S. application Ser. No. 14/626,012, filed Oct. 6, 2014, entitled “System and Method to Provide Collaboration Tagging for Verification and Viral Adoption” and to U.S. application Ser. No. 14/507,003, filed Feb. 19, 2015, entitled “System and Method to Provide Pre-Populated Personal Profile in a Social Network.”

### FIELD

The present invention applies to computer software, particularly Internet software that drives social networking applications.

### BACKGROUND

There exists prior art for presenting users of a social network with news feeds relating to their connections and activities within the network. User groups can form in many digital applications to share questions and answers on a forum, to share and exchange edits on documents, spreadsheets or other work product. Prior art exists that monitors activities and relationships to determine user affinity. News feeds that generate items based upon activities associated with a user and that user's relationships with other users exist in the social networking arena and are commonplace. Prior art also exists for limiting access to a predetermined set of people and allowing access to a private resource in an enterprise social network via a feed item. Additionally, prior art provides a customized feed for use in an organization based on reading activities and preference of other users in the same organization as well as methods to implement a project workflow in a social network feed.

### SUMMARY

One aspect of an embodiment of the present invention includes a method for use in operating a social network. The method comprises the steps of: providing the social network comprising a public section and a private section; providing access to the public section to all users of the social network; and providing access to the private section only to one or more users associated with at least a specific project or entity.

Another aspect of an embodiment of the present invention includes a non-transitory storage medium having software embodied therewith for use in operating a social network. The software comprises software configured: to provide the social network comprising a public section and a private section; to provide access to the public section to all users of the social network; and to provide access to the private section only to one or more users associated with at least a specific project or entity.

A further aspect of an embodiment of the present invention includes a system for use in operating a social network. The system comprises: a non-transitory storage medium having software embodied therewith; and at least one computer coupled to the non-transitory storage medium. The at least one computer is operative: to provide the social network comprising a public section and a private section; to provide access to the public section to all users of the social network; and to provide access to the private section only to one or more users associated with at least a specific project or entity.

### BRIEF DESCRIPTION OF THE DRAWINGS

The following drawings are presented by way of example only and without limitation, wherein like reference numerals (when used) indicate corresponding elements throughout the several views, and wherein:

FIG. 1 is a block diagram which conceptually depicts a general and personal news feed on a social network;

FIG. 2 shows a more detailed news feed scenario with additional private streams aggregated from a variety of public and private sources, according to an embodiment of the invention; and

FIG. 3 conceptually shows how users who collaborate on private community news feeds and projects can communicate updates to those with project privileges as controlled by the company or affinity group administrator, according to an embodiment of the invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of the present disclosure will be described herein in the context of illustrative methods and apparatus for providing a social network including a public section and a private section, wherein access to the public section is afforded to all users of the social network and access to the private section is restricted only to one or more users associated with a specific project or entity. It is to be appreciated, however, that the specific embodiments and/or methods illustratively shown and described herein are to be considered exemplary rather than limiting. Moreover, it will become apparent to those skilled in the art given the teachings herein that numerous modifications can be made to the embodiments shown that are within the scope of the appended claims. That is, no limitations with respect to the embodiments shown and described herein are intended or should be inferred.

Principles of the present invention may be applied to computer software, particularly Internet software that drives social networking applications, such as a system for social networking and/or social collaborating. Social networks are systems that permit users to become members and as members to utilize the system to socialize with other member users. A system according to an illustrative embodiment of the present invention may include an Internet site, website, application and/or software, and might be on a computer, smart phone, tablet or other user device and may be published in whole or in part or in summary in the system. The system may additionally and/or alternatively be deployed on computer media.

Many users of social networks need to do more than present their work and review or comment on the work of others. There is an urgent need for increased scope of collaboration on a private social network service that allows users and employees of a business or other affinity group to work on a dedicated community section of a social network with proprietary curated news feed and scope for collaborative work on private projects, before they become published work product. Such a service would give the private community or business the opportunity to specify and control how the latest information and updates relating to entity information and projects and products are distributed and to whom.

Embodiments of the present invention include methods to keep private certain news information and/or project data for availability to certain authorized people or users until such time as an authority determines that such certain information should be publically available on a social network system. Embodiments of the present invention may additionally and/or alternatively include a system of social network services consisting of public and private sections. In one or more embodiments, a private section is assigned to a business or other defined community with a need for private news feeds and entity-controlled private projects with full private collaborator communications; a public section of the social network service, in one or more embodiments, is accessible to all users. The news feed is often an integral and focal point of a social network and is typically displayed in a prominent position.

Principles of the present invention, in one or more embodiments thereof, provide a way for a social networking site to become much more valuable to specialized communities. An illustrative embodiment of the present invention is unique in that it offers the user of a social network a set of services that provides much more scope and capability than has previously been available. More particularly, one or more embodiments of the present invention include a system of private company social network services which provide a way for a social networking site to become much more valuable to a business by offering a private space with all the tools, features and functions of a public vertical social network. Specifically, it allows a company, or other business enterprise, to provide a firm-directed news feed along with specific privileges on a social network and presents an opportunity for different people, employees, members, users, or collaborators who are working on various enterprise projects to increase the level of communication and functional display when they are working together (i.e., collaborating) on a project while keeping the socialized information non-public prior to launching the project.

Private news and information about such projects, if authorized, may be available to specific users anytime they access the social network. A company or organization can appoint an administrator who can control certain aspects of access by every user using the public social network site and can specify who has access, which allows collaboration on projects with different levels of privacy. For example, access to privileged areas can be granted depending on whether the users are employees of the company, are working on a particular project or need access for a variety of other reasons. Anyone working on a project team could be added to that private area and use all of the scope and capabilities of the social network but not have it open to the general public until the project has been moved to the public side of the social network.

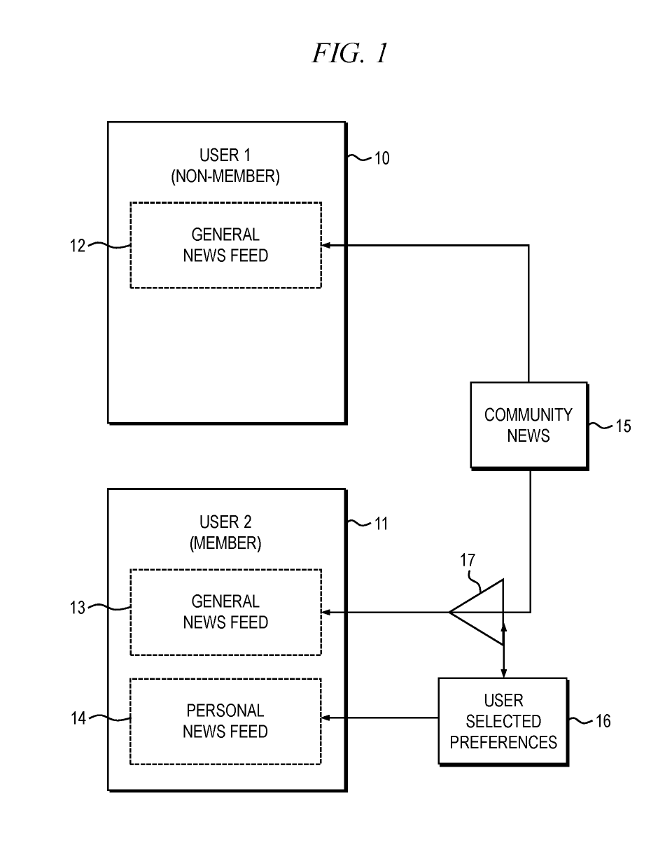

FIG. 1 conceptually depicts a general and personal news feed on a social network to illustrate a method of generating news feeds for both members and non-members of a social network. A user of the network who is either a non-member or has not logged-in, 10, is provided with a general news and data feed, 12, which lets him or her see what is happening in the community of the social network. The news source is curated by the social network operator and compiled into a general news data bank, 15, from a wide variety of public sources. A second user who is a member of the social network and who is logged-in to the system, 11, can also see the general public news and data feed, 13 supplied from the general news source location, 15, but will also be provided with the opportunity to apply a filter, 17, where user-selected preferences, 16, can be applied in order to personalize the news feed, 14. Such preferences, 16, may include people that the user follows or segments of the network community of interest that is of specific interest to him or her.

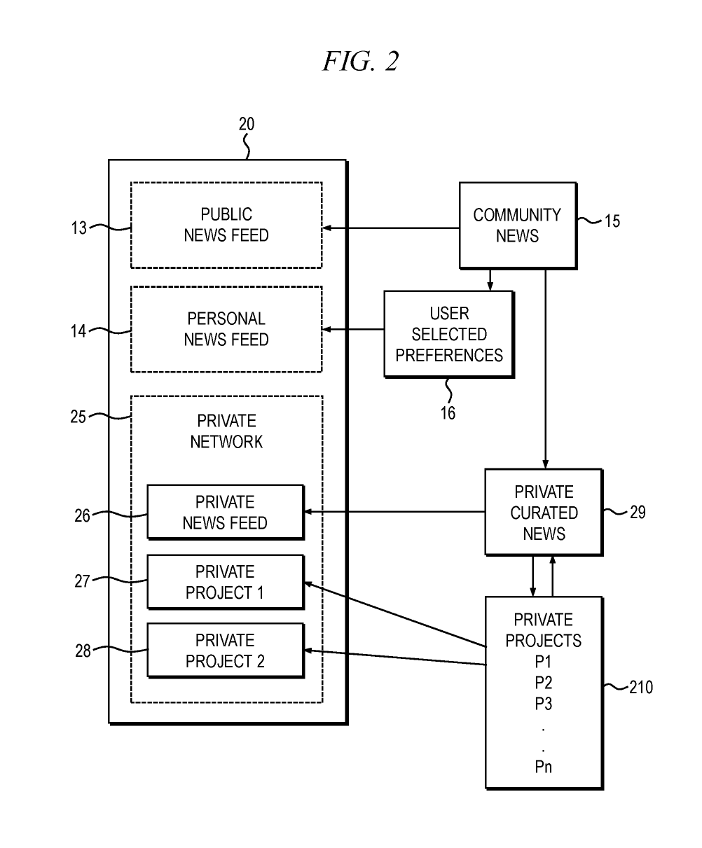

FIG. 2 shows a more detailed news feed scenario with additional private streams aggregated from a variety of public and private sources, in accordance with an embodiment of the invention. Thus, FIG. 2 shows components of exemplary private services that a social network deploying an illustrative embodiment of the present invention can make available to member users. The information presented and available to a specific user employing some personal privacy options, 20, can include the public community news feed, 13, the user's personal news feed, 14, and private network information, 25, which can include a private news feed, 26, and certain private projects, 27-28. The method for delivering these features and services begins with the community news, 15, that can be filtered by the user-selected preferences, 16. In addition, the method drives the system to access private curated news, 29, obtained from sources outside the social network community. Furthermore, the system can permit the user to designate certain projects P1, P2 . . . Pn, 210, as private and not available to the general social network community. These projects may be unfinished work in progress or completed works of a confidential nature. Access to the private curated news can be shared with other specific users on the system. In another embodiment, access to view or edit certain private projects may be granted to certain users on the network. Such private sections of the social network allow a user to manage a small area of private news and projects with a close group of working collaborators in order to enhance their efforts without the requirement to permit full community access to sensitive projects or information.

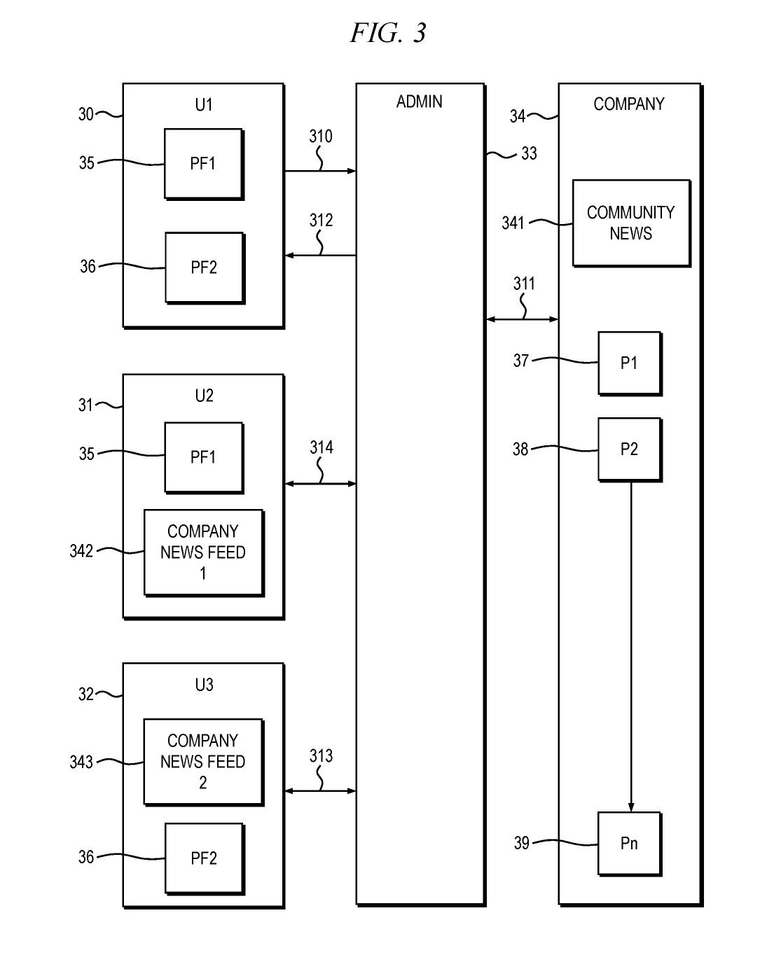

FIG. 3 shows a further development of social network systems to incorporate larger company-level needs, in accordance with an embodiment of the invention. In particular, FIG. 3 shows a method by which users who collaborate on private community news feeds and projects can communicate updates to those with project privileges as controlled by the company administrator. The method links a company or other entity, 34, through an administrator, 33, with a number of users, 30, 31, 32. In other embodiments, the company 34 could be a team, a league, an organization with members or member companies or other similar configuration. In other embodiments, the administrator 33 could be a single person, an office or an entire organization. The users of the social network, U1, 30, U2, 31, and U3, 32, could be individuals, employees of the company 34, or members of the organization 34, or anyone else authorized by the methods in the system used by the administrator 33. The company or organization 34 can curate or write a company news feed, 341, that can be filtered and delivered to any number of users in a vast number of filtered formats such as company news feed 1, 342, accessed by a user, 31, and company news feed 2, 343, available to another user, 32. Similarly, the system can support any number of private company projects and news and updates associated with them as depicted by projects P1, 37, P2, 38, continuing to Pn, 39, where n is an integer. User U1, 30, as a collaborator on two projects, P1, 37 and P2, 38 receives updates about them, and may have administrator authorization to edit the projects in his work space, PF1, 35 and PF2, 36. Private information on his company and his work is delivered to him via feed, 312. Similarly, his work or edits on projects 1 and 2, 35 and 36, and any private news updates on these projects is driven, subject to administrator 33 authorization, by feed, 310, to the company private news system, 341, for dissemination to those who need to know such as users 2 and 3, 31 and 32. User U2, 31, only works on project P1, 37, and therefore only gets project information on PF1, 35, and a private company news feed specific to his needs, 341 with two-way update and edit capability via link, 314. User 3, 32, has similar project information PF2, 36 and news feed 2, 343, with two way access and edit capability, 313 on project P2, 38.

All of the private news feed is controlled by the administrator, 33, and is available to all company employees (who are those users identified by a company email address) or whoever uses the system, or those given access by the administrator as appropriate for different levels of information and specific projects. Collaborators can share information for a current project via the news feed without having to access a separate email or messaging system. Their updates concerning a specific project are directed via the administration system to those who are authorized for such updates. Once there is a project launch or other public event, the privacy restrictions can be removed, and the project can be viewed by users across the social network system.

What is claimed is:

1. A method for use in operating a social network, the method comprising the steps of:
providing the social network comprising a public section and a private section;
providing access to the public section to all users of the social network;
providing access to the private section only to one or more users associated with at least a specific project or entity.

2. The method of claim 1, wherein providing access to the private section comprises:
providing information about the entity only to one or more users associated with the entity; and
providing information about at least a given one of one or more projects only to one or more users associated with at least the given one of the one or more projects.

3. The method of claim 2, wherein:
the public section comprises a first news feed; and
the information about the entity comprises a second news feed;
wherein the first news feed is at least one of curated by and written by an operator of the social network; and
wherein the second news feed is at least one of curated by or written by the entity.

4. The method of claim 3, further comprising personalizing the first news feed for a specific user at least in part by using a filter to apply one or more preferences selected by the specific user to the first news feed.

5. The method of claim 3, further comprising:
at least one of the one or more users associated with at least the given one of the one or more projects providing information about at least the given one of the one or more projects for potential publication in the second news feed; and
personalizing the second news feed for a specific user at least in part by publishing the information about at least a given one of one or more projects in the second news feed only if the specific user is associated with at least the given one of the one or more projects.

6. The method of claim 1, wherein the one or more users associated with a specific project or entity are determined at least in part by an administrator of the entity.

7. The method of claim 1, wherein the access to the private section provided to at least a given one of the one or more users associated with a specific project or entity is determined at least in part by an administrator of the entity.

8. The method of claim 1, wherein the one or more users associated with a specific entity comprise one or more employees of at least one of a company and a business enterprise.

9. The method of claim 1, wherein the one or more users associated with a specific entity comprise one or more members of at least one of: an affinity group, a team, a league, an organization, and a community.

10. The method of claim 1, further comprising:
at least one of the one or more users associated with a specific project designating one or more other users as being associated with the specific project; and
providing access to the private section to the one or more other users designated as being associated with the specific project.

11. The method of claim 10, wherein access to the private section is provided to the one or more other users designated as being associated with the specific project only after approval by an administrator of the entity.

12. The method of claim 10, wherein the access to the private section provided to at least a given one of the one or more users designated as being associated with a specific project or entity is determined at least in part by an administrator of the entity.

13. The method of claim 1, further comprising allowing an administrator of the entity to transfer the specific project from the private section to the public section, thereby providing access to the specific project to all users of the social network rather than only the one or more users associated with the specific project.

14. The method of claim 1, further comprising allowing at least one of the one or more users associated with the specific project to edit the specific project in a workspace of the at least one user.

15. The method of claim 1, wherein providing access to the private section only to one or more users associated with at least a specific project comprises providing access to each of a plurality of projects within the private section only to one or more users associated with the respective project.

16. The method of claim 15, wherein providing access to the private section only to one or more users associated with at least a specific project further comprises providing access to the private section only to one or more users associated with at least one of the plurality of projects within the private section.

17. The method of claim 15, wherein providing access to the private section only to one or more users associated with at least a specific project further comprises providing access to the private section only to one or more users associated with at least one of:
the entity; and
at least one of the plurality of projects within the private section.

18. The method of claim 1, wherein providing access to the private section only to one or more users associated with at least a specific project or entity comprises:
providing access to the private section only to one or more users associated with at least an entity; and
providing access to each of a plurality of projects within the private section only to one or more users associated with the respective project.

19. A non-transitory storage medium having software embodied therewith for use in operating a social network, said software comprising:
software configured:
to provide the social network comprising a public section and a private section;
to provide access to the public section to all users of the social network; and
to provide access to the private section only to one or more users associated with at least a specific project or entity.

20. A system for use in operating a social network, said system comprising:
a non-transitory storage medium having software embodied therewith; and
at least one computer coupled to the non-transitory storage medium;
wherein the at least one computer is operative:
to provide the social network comprising a public section and a private section;
to provide access to the public section to all users of the social network; and
to provide access to the private section only to one or more users associated with at least a specific project or entity.
